(19) United States
(12) Patent Application Publication
(10) Pub. No.: US 2012/0123839 A1
(43) Pub. Date: May 17, 2012

(54) System and Method for Providing Advertising to a Wireless User Device

(75) Inventors: Steven Blake, San Mateo, CA (US); Jeffrey Blake, Bloomfield Township, MI (US); Lener Pacania, Ypsilanti, MI (US); Matthew Paroly, Bloomfield Hills, MI (US); Todd Riley, Grosse Pointe Park, MI (US); Gavin McCarty, Inverness, IL (US)

(73) Assignee: CONEXUS, LLC, Bloomfield Township, MI (US)

(21) Appl. No.: 13/360,053

(22) Filed: Jan. 27, 2012

Related U.S. Application Data
(63) Continuation of application No. 12/898,140, filed on Oct. 5, 2010.
(60) Provisional application No. 61/251,937, filed on Oct. 15, 2009.
(60) Provisional application No. 61/357,395, filed on Jun. 22, 2010.
(60) Provisional application No. 61/369,127, filed on Jul. 30, 2010.

(51) Int. Cl. G06Q 30/02

(52) U.S. Cl. 705/14.16; 705/14.4

(57) ABSTRACT

A system and method for providing wireless service includes a user device and a service provider. The service provider communicates the advertisement to the user device. The user device has a display control module that generates a first screen display at the user device comprising the advertisement and a lockout module that locks at least some device functions. The user device includes a user interface that interacts with the advertisement on the first screen display and allows access to the data or voice function. The service provider may provide a wireless service plan having a rate based upon receiving advertisements and interacting with the advertisements.

### CROSS-REFERENCE TO RELATED APPLICATIONS

This application is a continuation of U.S. patent application Ser. No. 12/898,140 filed on Oct. 5, 2010, which claims the benefit of U.S. Provisional Application Nos. 61/251,937, filed on Oct. 15, 2009, 61/357,395, filed on Jun. 22, 2010, and 61/369,127, filed on Jul. 30, 2010. The disclosures of the above applications are incorporated herein by reference.

### TECHNICAL FIELD

The present disclosure relates generally to a system for providing advertising to a wireless user device and, more specifically, to a method and system for providing advertising offers or other commercial messaging to the wireless user device.

### BACKGROUND

The statements in this section merely provide background information related to the present disclosure and may not constitute prior art.

Generally, commercial mobile radio service (CMRS) providers are mobile carriers whose wireless network may be operated upon a public telephone network and/or whom operate a mobile wireless service for profit. The carriers may be a traditional mobile network operator (MNO), a mobile virtual network operator (MVNO), a mobile network enabler (MNE) or any other carrier that provides mobile services directly or indirectly to a customer. Such carriers generally offer customers a number of service plans or packages which may include services that satisfy the customer's particular needs and wants. Each service or rate plan offered may offer access to the carrier's mobile system with variable monthly charges based on the amount of voice, text and data utilized and/or a fixed monthly charge for specified amounts of monthly voice minutes, text and data.

For example, a carrier or other components of the service provider, such as Sprint or Verizon, may offer a customer a series of rate plans whose costs vary based upon the customer's usage per month. Such rate plans may be of a limited or unlimited nature and may include such additional services such as text and data usage for a nominal or additional cost. For example, a rate plan may be offered which allows the customer 800 minutes of voice calls per month, in addition to, a limited amount of text and Internet searching and web access.

However, the rate plan described above typically does not include any additional fees a customer may also incur during the monthly operation of the mobile device. Such additional fees may include activation or startup fees, international usage or call fees, directory assistance, administrative fees, regulatory fees, taxes and surcharges.

Additionally, due to a shift in personal, as well as, professional lifestyles, customers or users have begun to rely more greatly on their mobile devices for everyday voice usage. Such a reliance on one's mobile device has increased as many customers have begun eliminating their home or land line service and switching solely to using their mobile device. Furthermore, with the growth of the PDA and smart phone market (e.g., iPhone, Blackberry, or Windows Mobile Device) customers have also begun to rely on their mobile device for Internet e-mail access, web surfing and/or texting. Such reliance has accelerated as more business customers have become dependent upon a connection between their mobile device (e.g., Blackberry and iPhone) and a work e-mail server or network.

### SUMMARY

The present disclosure provides a system and method for providing a cost-effective wireless service for customers based upon receiving advertising at a user device. As will be described below, the advertising may be communicated directly to the user device. The advertising may be general or may be directed or targeted.

In one aspect of the disclosure, a method includes associating attributes with a user device, associating advertising traits to an advertisement, comparing attributes with the advertisement, communicating the advertisement from the carrier to the user device, generating a first screen display at the user device comprising the advertisement, prior to accessing user device functions, interacting with the advertisement on the first screen display in response to interacting, accessing user device functions and providing a wireless service plan at a rate based upon interacting with the advertisement.

In a further aspect of the disclosure, a system for providing wireless service includes a user device and a carrier that stores attributes for the user device. The carrier collects and stores a customer profile and uses that profile to match a user to an advertisement. The carrier analyzes the user attributes and matches the correct advertisement to that user. The advertisement is delivered through the user device. The user device has a display control module that generates a first screen display at the user device comprising the advertisement and a lockout module that locks at least some user device functions. The user device includes a user interface that interacts with the advertisement on the first screen display and allows access to the user device function that was locked. The carrier provides a wireless service plan having a rate based upon interacting with the advertisement.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagrammatic view of a communication system for communicating advertising content according to the present disclosure.

FIG. 2 is a block diagrammatic view of a user device.

FIG. 3 is a block diagrammatic view of the carrier.

FIG. 4 is a block diagrammatic view of the data warehouse of FIG. 3.

FIG. 5 is a representation of a user queue according to the present disclosure.

FIG. 6 is a view of a screen display having an advertisement thereon.

FIG. 7 is a screen display of a file storage juncture.

FIG. 8 is a screen display of an interactive portion of an advertisement after a “yes” key has been selected from the advertisement.

FIG. 9 is a workflow diagram of the user device.

FIG. 10 is a workflow diagram of the server of the carrier.

FIG. 11 is the high-level flowchart of a method for operating the system.

FIG. 12 is a flowchart of a method for activating a user.

FIG. 13 is a flowchart of a method for creating an advertisement and delivering an advertisement.

FIG. 14 is a flowchart of a method for interacting with an advertisement.

FIG. 15 is a method of targeting a user device.

FIG. 16 is a flowchart of a method for providing a referral to the carrier.

FIG. 17 is a simplified block diagrammatic view of a system for waking up and initiating an application.

FIG. 18 is a flowchart of a method for waking up and initiating an application.

### DETAILED DESCRIPTION

The following description is merely exemplary in nature and is not intended to limit the present disclosure, application, or uses. For purposes of clarity, the same reference numbers will be used in the drawings to identify similar elements. As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical OR. It should be understood that steps within a method may be executed in different order without altering the principles of the present disclosure. The words ad, advertisement and advertising are used throughout the disclosure to refer to all forms of commercial speech and information including, but not limited to, fixed page advertising, links, coupons, sequential advertising that requires the user device interaction, and various other types of advertising.

The present disclosure provides a system and method that allows a service provider to offer rates based upon the user granting permission to receive advertising on the user device. The user of a user device views and interacts with the advertising. The advertising can be generally provided or targeted to users of the user device based on various user providing attributes that are applied within the system. The user attributes may also evolve over time. That is, the user attributes may gradually be changed based upon feedback based upon user responses to various advertisements and updating survey data. The advertisements may be informational advertisements or promotional advertisements. For example, coupons may be provided to a user device that allows the user device display to be scanned at the checkout of a store or restaurant.

The cost of the wireless service is thus ultimately subsidized by fees paid by the advertisers. Advertisers may desire this service because it allows advertising on the first screen of the user device and because detailed demographics and user information may be used to target specific users with attributes. Advertisers with specific targets in mind may find overall advertising campaign costs being reduced and increased efficiency and higher response rates since the ads are directed only to the targeted audience rather than to a number of customers, many of whom are not part of the target audience. That is, blanket advertising may be reduced or avoided.

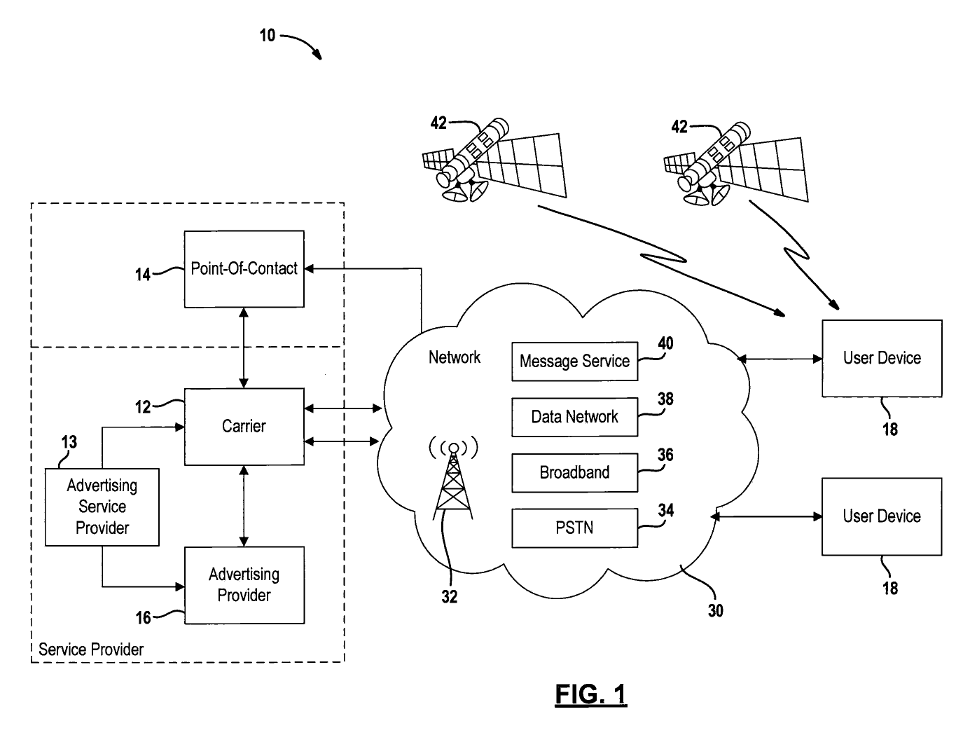

Referring now to FIG. 1, a high-level block diagrammatic view of a communication system 10 is illustrated. The communication system 10 may include a carrier 12. The carrier 12 may be the provider of voice and data services. Various types of services may be provided by the carrier 12 that include voice, internet, texting and any other types of fee-based services.

An advertising service provider 13 may provide advertising services through the carrier 12. The advertising service provider 13 and carrier 12 may be separate entities or the same. As separate companies, the advertising service provider 13 may be a point-of-contact company for end users. The advertising service provider 13 may contract with the carrier for access to the network 30. Billing and contract with user devices may be performed by the advertising service provider 13.

The carrier 12 may be in communication with a point of contact location 14. The point of contact location 14 may be an internet location used for ordering a service and a user device for the service. The point of contact location 14 may also be a customer call service center that receives customer calls to order a service and a user device. It should be noted that a customer may have a user device from another carrier that may be used for services from the carrier 12 illustrated in FIG. 1. The point of contact location 14 may provide the customer with various types of service options as well as enabling a service. Various types of data may be collected at the point of contact location 14. The data may be associated with the user and a particular user device associated with an account. The point of contact location 14 may be used for various functions not limited to initializing an account, coordinating the billing, and enabling devices.

The point of contact location 14 may also be a physical location such as a brick-and-mortar store or kiosk. In such a manner, the store employees may obtain the data, open an account, and provide the user devices to customers.

The point of contact location 14 may provide options to customers regarding various rate plans. For example, according to the present disclosure, a discounted rate plan compared with conventional carriers or reduced rate service may be obtained for agreeing to receive and to interact with advertising. By agreeing to interact with advertising, the user may obtain a free or reduced rate from a base rate. The base rate may be a charge for customers who do not accept advertising. Various rates including a second reduced rate for viewing and interacting with advertising at a higher rate of advertisements than the first reduced rate may also be offered.

Interaction with an advertisement may be performed by operating a user interface of the user device. As will be described in detail below, interactions such as “yes the user is interested in further information relative to the ad,” “no the user is not interested in the content of the ad” and “saving the ad for later” may be performed.

Various rate plans may also be provided for the amount of voice and data utilized. Further, other rate plans may be provided with a predetermined number of downloaded bytes. Rate plans with various number of agreed upon advertisements may be combined with various voice and data plans.

An advertising provider 16 may provide advertising to the carrier 12 or to the advertising service provider 13 for distribution to the user devices 18 through the carrier 12. The advertising provider 16 may provide advertising as well as advertising traits to the carrier 12. The advertising traits may provide the carrier 12 or advertising service provider 13 with target traits for targeting the user devices having various attributes. The advertising traits may include demographic information for desired users, times for communicating the advertisement, locations suitable for communicating the advertisements to, and various other desired user device attributes such as, but not limited to, home address, income, marital status, children's ages, children's gender, hobbies and education level. The advertising traits may be communicated in an advertising signal together with the advertisement or as a separate signal that identifies the corresponding advertisement.

Interaction between the carrier 12 and advertising provider 16 may also be provided in a billing context. That is, the carrier 12 may bill the advertising provider 16 a certain amount per advertising delivered. The types of advertising delivered may also include coupons, links, and other interactions initiated by the user device in response to an initial advertisement. Such processes will be described below.

It should be noted that the advertising provider 16 may be a plurality of advertising providers in a constructed embodiment. The carrier 12 may interact with various numbers of advertising providers that provide various types of advertising. The advertising may also provide the user with various types of product information, service information, or allow customers to fill in a survey or sign up for a service.

The components such as the point of contact 14, carrier 12, advertising service provider 13 and advertising provider 16 may be a single entity or component, or separate. Individually, collectively or in various combinations, they may be referred to as a “service provider” 20. The service provider 20 may perform all or some of the functions of the system that interact with a network 30.

The carrier 12 and other components of the service provider 20 may communicate with the user devices 18 through the network 30. The network 30 may be one network or a plurality of networks. The networks may include, but are not limited to, a cellular or mobile phone network 32, a public switched telephone network 34 (PSTN), a broadband network 36, a data network 38, and a message service 40. The network 30 may be used for communicating different types of data to the user devices 18. For example, the user device 18 may use a broadband network 36 for communicating emails or other data instructions to the carrier 12 and vice versa. The user device 18 and carrier 12 may also exchange text video, pictures and other types of data messages through the message service 40. Voice communications may take place between the carrier 12 and user device 18 through the public service telephone network 34. Advertising may be communicated from the carrier 12 to the user device through one or more of the networks. Responses and data, such as keystroke data signals, may be communicated from the user device 18 to the carrier 12 through one of the different types of networks.

The user device 18 may also communicate a location to the carrier 12. That is, a location signal may be communicated from the user device 18 to the carrier 12 through the network 30. A location signal may be determined in many ways, including using GPS satellites 42. The GPS satellites 42 may use known triangulation techniques to determine the location of user device 18. Other triangulation techniques, such as the use of cell towers of the wireless phone network 32, may also be used. Triangulation techniques that use signals from various cellular towers of a wireless phone network 32 may be used.

The service provider 20 may also communicate application upgrades and downloads to the user device 18 through the network 30. Monitoring and reporting applications may also be processed between the service provider 20 and the user device 18 through the network 30.

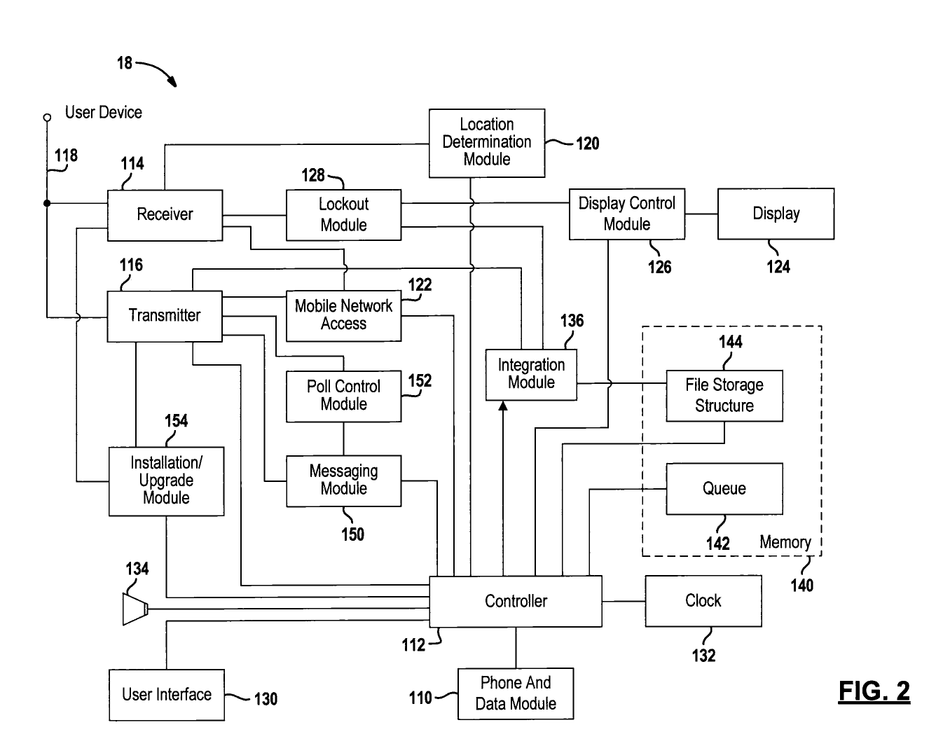

Referring now to FIG. 2, a user device 18 is illustrated in further detail. The user device 18 may be one of a number of types of user devices, including a cellular or mobile phone or a personal digital assistant. The user device 18 may include various types of voice and data functions that are controlled by a phone and data module 110. The phone and data module 10 may include decoding and processing various phone and data signals. These may include operation of the user device and set-up of the user device or a data device itself.

A controller 112 controls the interaction of the various processes within the user device. FIG. 2 is meant to illustrate the features most closely associated with the present disclosure. Other features typically found in a mobile device may also be incorporated in the controller 112. The user device 18 may include a receiver 114 and a transmitter 116. The receiver 114 and the transmitter 116 are used to receive and transmit voice signals and data signals, respectively. The receiver 114 and the transmitter 116 are in communication with the network and ultimately to the service provider through the antenna 118. Although only one antenna 118 is illustrated, multiple antennas may be provided within the user device 18.

The antenna 118 and receiver 114 may also be in communication with a satellite or cellular towers for determining a location of the user device. The location determination module 120 may generate a location signal that is ultimately communicated to the transmitter 116 that communicates with the network 30 and the carrier 12.

A mobile network access module 122 may be used to access the mobile network. The mobile network access module 122 may communicate voice and data signals to and from the receiver 114 and transmitter 116. Access codes and the like may also be provided by the mobile network access module.

The user device 18 may also include a display 124. The display 124 may be used for displaying various types of data, including an advertisement. The advertisement may be displayed with the help of a display control module 126. As mentioned above, certain functions of the user device 18 may be locked using a lockout module 128 when the display is displaying an advertisement. Interaction with the display 124 and the advertisement may allow the user device functions to be unlocked. That is, the voice and data service may be locked out by a lockout signal generated from the lockout module 128. The display 124 may be various types of displays, including a touch screen display. Some functions such as 911 calling may continue to be accessible.

A user interface 130 may be enabled to interact with the advertisement. The user interface 130 may be incorporated into the display a touch screen. The user interface 130 may include buttons or a keypad that generate keystroke signals to the controller 112. The lockout module 128 may prevent the user interface 130 from performing most or all other functions besides the limited functions associated by the advertisement. For example, the display may allow a limited amount of user device activity such as responding to a yes key, a no key or a save key. These keys may be display keys on a touch screen or physical keys of the user device 18f. In some embodiments, pressing a “home key” on a device may allow a temporary bypass to the advertisement but the user device may display the bypassed ad until an interaction takes place.

The controller 112 may also be in communication with a clock 132. The clock 132 may be a time clock used for determining the present time and or timing the relative time between different events.

The controller 112 may also be in communication with a speaker 134 that generates audible signals corresponding to various functions or keystrokes performed by the system.

The controller 112 may also be in communication with the interaction module 136. The interaction module 136 may monitor the interaction with the user interface 130. The interaction module 136 may record the keystrokes or other interaction with the display 124 or the user interface 130. The interaction signals, such as keystroke signals, may be communicated through the mobile network access module 122 and through the transmitter 116 and ultimately to the carrier 12 illustrated in FIG. 1.

A memory 140 may also be in communication with the controller 112. The memory 140 may include various types of memory, including RAM or ROM. Flash memory may also be used. The memory 140 may include a queue 142 and a file storage structure 144. The queue 142 may be a queue that is suitable for storing and saving various advertisements to be displayed on the display 124. The file storage structure 144 may be used to store or “save” advertisements that have been interacted with that the user would like to later display or recall. The file storage structure, for example, may include various files for storing different types or categories of advertisements. The advertisements may include coupons. The file storage structure may be categorized so that retrieval of various types of files or coupons may be achieved rapidly. As will be described below, the ad signals may include file storage structure identifiers so that they may be placed automatically within a file storage structure upon pushing or selecting a “save” key.

The user device 18 may also include a messaging module 150 that may provide a short message service (SMS) and multimedia messaging service that is used for generating and receiving short text messages, videos, pictures, text pages and the like. The messages between the user device 18 and carrier 12 may include instructions, data, advertisements and polling signals.

A poll control module 152 is used for generating poll signals for the user device and communicating the poll signals to the carrier 12. The poll signals from the poll control module 152 may result in new advertisements being communicated to the user device 18. The poll control module 152 may generate poll signals at various times according to a predetermined schedule so that advertisements may be communicated to the user device based upon a user agreement for receiving messages.

An installation/upgrade module 154 may allow the user device 18 to maintain the versions and upgrade the versions of the operating software for the system. Installation may also take place using the installation/upgrade module 154. While communicating to the carrier 12, the operating software version may be communicated so that if a new version is available, the new version may be communicated from the carrier 12 to the user device.

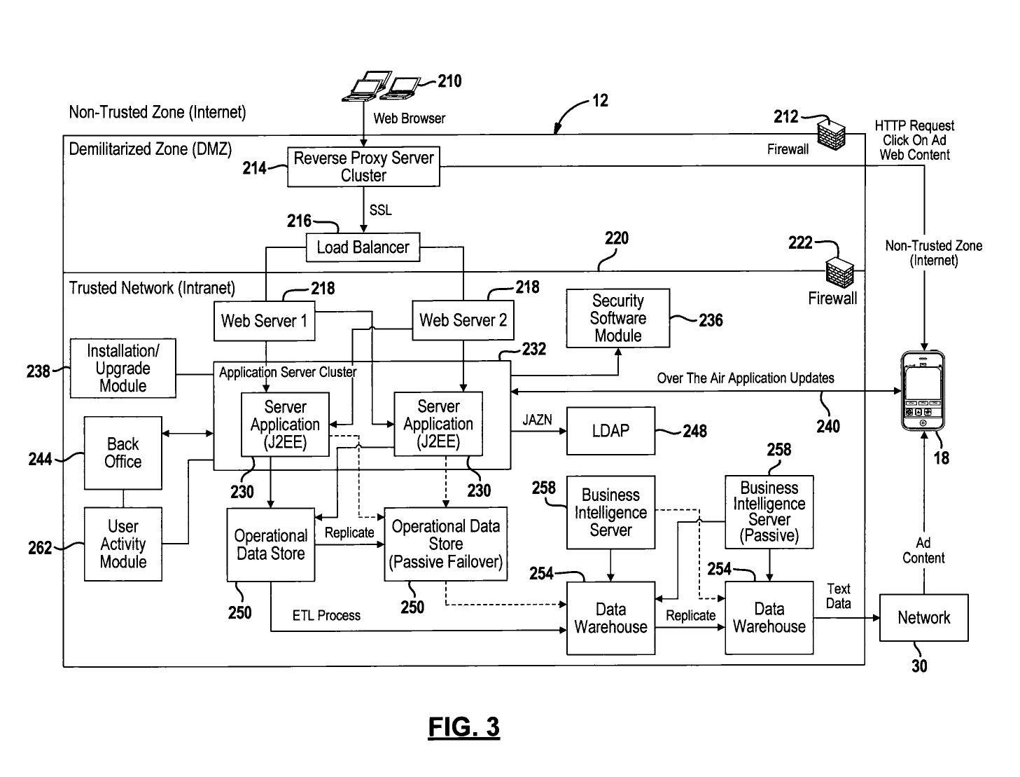

Referring now to FIG. 3, the carrier 12 is illustrated in further detail. The carrier 12 may be accessed by the user device 18 and other devices that may include a web browser 210. The user device 18 and/or web browser 210 may communicate through a firewall 212 to a reverse proxy server cluster 214. The reverse proxy server cluster 214 may include a plurality of reverse proxy servers. The number of reverse proxy servers in the reverse proxy server cluster 214 may vary, depending on the size of the system. It should be noted that the reverse proxy server cluster 214 may include one or a number of reverse proxy servers depending on the system requirements.

The reverse proxy server clusters receive communications from a plurality of user devices 18 and provide a secure sockets layer signal to a load balancer 216. The load balancer may communicate through web servers with redundant web servers 218 that are disposed within a trusted intranet 220 through a firewall 222. The system may include a plurality of server applications 230 disposed within an application server cluster 232. The server applications may be JAVA- (J2EE) based. The application server cluster 232 controls the various functions of the carrier or other components of the service provider. The application server cluster may be used to control the upgrading of various user devices, control and maintain various data storage devices, and coordinate communication of advertisements to the user devices 18.

A security software module 236 may be in communication with the application server cluster 232. The security software module 236 may provide secure communications between the server applications 230 and the user devices 18. The security software module 236 may also supply security for communications with the advertising provider 16 of FIG. 1.

The server applications 230 may also be in communication with an installation/upgrade module 238. The installation/upgrade module 238 may provide over-the-air application updates 240 to the user device 18 when the user device 18 no longer contains the most recent version of the application.

The server applications 230 may also be in communication with a back office 244. The back office 244 may include various functions, including the functions at the point of contact location 14 illustrated in FIG. 1. The back office 244 may include sales of new user devices to various users, asset management of data and coordinating the data with the user devices, billing for the user devices, as well as billing for the advertising providers.

A user directory service 248 such as a light-weight directory access protocol (LDAP) 248 is an application protocol for querying and modifying data using directory services. The user directory service 248 may operate using TCP/IP protocol. The user directory service 248 may use a JAVA authorization (JAZN) for authorizing data. The user directory service 248 may thus be used to organize data in a database.

The application server cluster 232 may also be in communication with an operational data store 250. As illustrated, two operational data stores 254 are illustrated for redundancy. The operational data store 250 is used to integrate data from multiple sources and resolves redundancy for the data. The operational data store 250 uses an extract, transform, load (ETL) process to provide data to a data warehouse 254. As illustrated, two data warehouses 254 are illustrated for redundancy. Each data warehouse 254 is used to store various data associated with the carrier 12. The data warehouse 254 may include data provided during entry of a new user device 18 into the system. Further, the data warehouse aggregates the data for the Business Intelligence Servers 258 and may store various advertisements, targets for the advertisements, and attributes of the users.

Redundant business intelligence servers 258 are illustrated in communication with the data warehouse. The business intelligence servers 258 may perform analytics by comparing the user attributes to the targets of the ads so that proper advertisements may be provided to the user devices. As will be described below, a queue may be formed consisting of various advertisements that are to be provided to the user devices 18.

A user activity module 262 may receive data ultimately from the user device corresponding to user activity. The user activity may monitor and store keystrokes within the data warehouse 254 and may also monitor other user activities such as following links provided in an advertisement, and the like. The user activity module 262 may be linked to the back office 244. Based upon various user interactions with the advertisements, the back office 244 may bill the advertisers based upon the user activity.

The data warehouse 254 communicates through the network 30 to the user device 18.

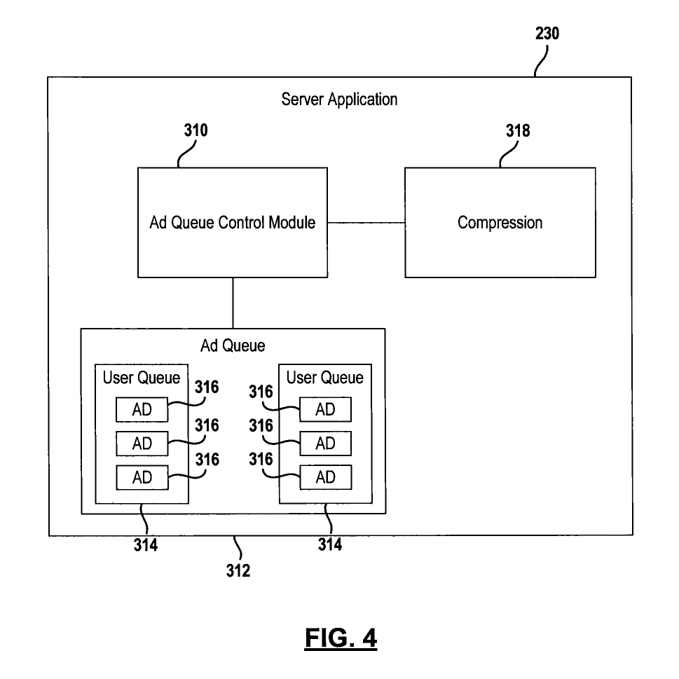

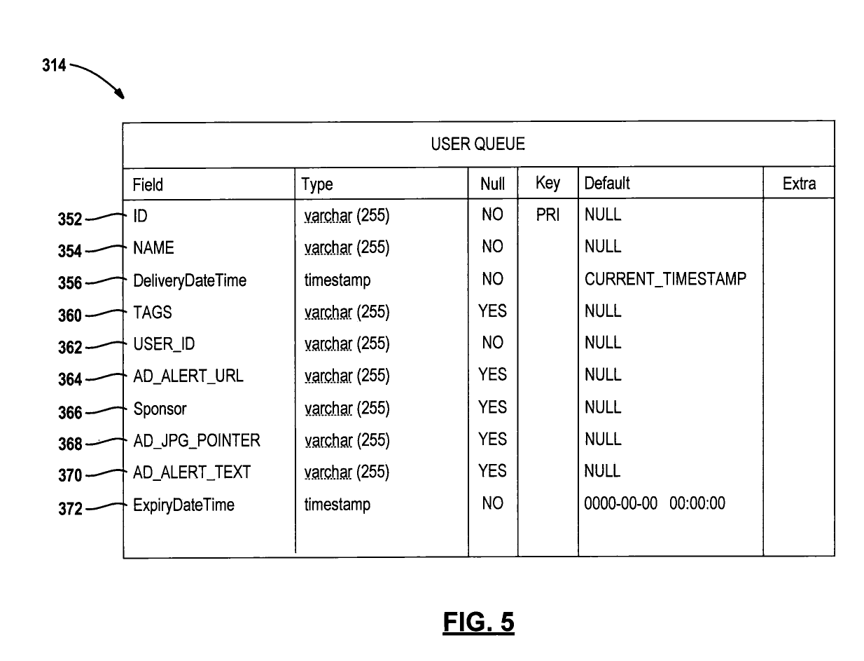

Referring now to FIG. 4, a server application is illustrated in further detail. The server applications 230 may include an ad queue control module 310. The ad queue control module 310 may control the ad queue 312. The ad queue 312 may include a plurality of user queues 314. A user queue 314 may correspond to a queue for the user device 18. That is, the ad queue 312 may include a plurality of user queues 314 for each user. The user queues may be an ordered set of advertisements 316 to be broadcast to the various user devices 18. An example of the user queues is illustrated in FIG. 5. The server applications 230 may also include a compression module 316. The advertisements may be compressed prior to them being communicated to the user device 18. Although the compression control module 318 is illustrated in the server applications 230, the compression control module may be located as a separate module or within another module. The compression control module 318 may compress the advertisement just prior to communication of the advertisement to the user device.

Referring now to FIG. 5, an example of a user queue 314 is illustrated. The user queue 314 may have a user queue identifier 350 for each user queue. The user queue 314 may be an ordered set that may include, but is not limited to, an advertisement (ad) ID 352, a name 354, a delivery date time 356, tags 358, a user identifier 362, an ad alert URL 364, a sponsor identifier 366, an ad pointer 368, an ad alert text 370 and an expiring date-time 372. The advertisement ID 352 and name 354 may each be a numeric or alphanumeric identifier that identifies the ad within the data warehouse. The delivery time identifier 356 may identify the time of day suitable for delivering the ad. When the time of day at the user device 18 is outside the time of day recommended for the ad, the ad may not be delivered and a subsequent ad may be delivered. For example, an ad may be suitable for the morning or another time period of the day. That is, a free cup of coffee may be offered during breakfast time at a local fast-food chain. Outside of that time window, the ad may no longer be suitable. The user ID 362 identifies the user device identified for the ad. The sponsor 368 may be a sponsor identifier for the ad. The ad pointer may provide a pointer for the ad location. The ad alert 370 may provide an alert text for the ad.

The expiration time column 356 may provide an expiration time for the advertisement. When the time is past the expiration time, the advertisement may no longer be delivered. Some offers by some advertisers may only be for a limited time and thus may not be suitable for delivery after the expiration time. The expiration time may be in a month, day, year, and hour format. The expiration time may expire on a predetermined day or at a predetermined time of a predetermined day.

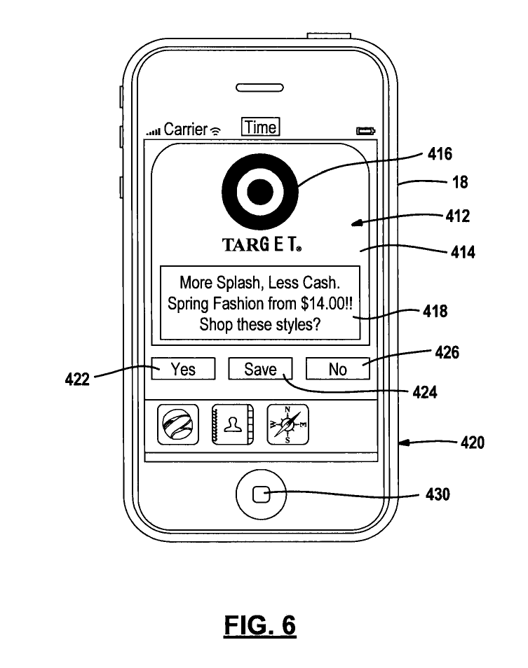

Referring now to FIG. 6, a user device 18 includes a screen display 412 that includes an advertisement 414. The screen display 412 is generated as an overlay by using an override function. The advertisement 414 may be initiated by the user device or server as will be described below. The advertisement 414 may include an advertiser identifier 416 and a message 418. The advertisement 414 may also include selection keys 420 that are part of a user interface. The selection keys 420 may include a “yes” key 422, a “save” key 424, and a “no” key 426. The advertisement 414 may have links to other information. By interacting with the ad by selecting the “yes” key 422, further information may be provided to the user. By selecting “yes,” the keystroke associated with “yes” may be communicated back to the carrier 12 so that the user profile may be updated. By selecting the yes key 422, a coupon may be delivered to the target device. A link may be provided or further information may also be communicated to the user device.

By interacting with the ad by selecting the save key 424, the advertisement 414 may be saved within a file storage structure. The file storage structure may have predetermined file categories. The file categories may be pre-assigned to the advertisements so that when saved they automatically are saved within a file category folder. The advertisements may be saved for later viewing by the user of the user device. Saved as may also be redisplayed after a predetermined period of time so that the user does not forget or lose track of the advertisement.

The “no” key 426 may also be interacted with by a user. A no key selection provides a signal corresponding to the “no” keystroke indicating to the carrier or other components of the service provider that the user is not interested in the advertisement.

The yes key 422, the save key 424, and the no key 426 may all be touch-screen keys, as illustrated. However, the user device 18 may have fixed buttons with a corresponding function.

A home button 430 may also be provided on a device. The home button 430 may perform multiple functions depending on the screen display. The home button 430 may or may not be used depending upon system requirements.

As mentioned above, all of the user device functions (or nearly all) may be locked until the advertisement is interacted with by the user. One function that may be enabled is a “service” key 516 that may be pressed for assistance if technical problems are encountered with the advertising-based system. Other keys such as a phone book key 518 or navigation key 520 may be disabled until the ad is interacted with.

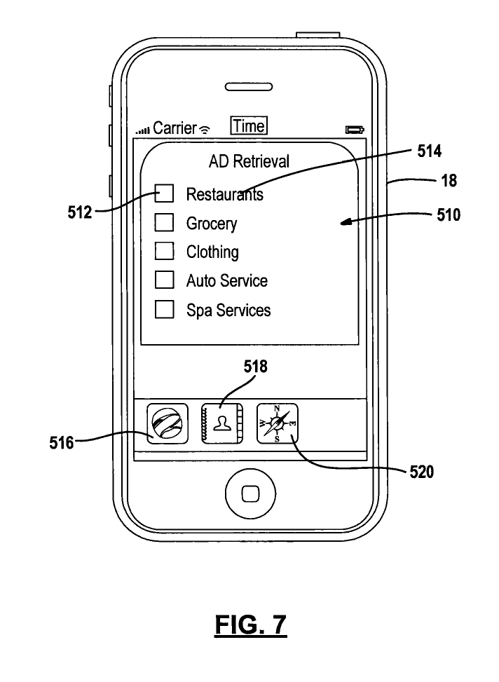

Referring now to FIG. 7, the file storage structure used when storing files is illustrated. The file storage structure 510 may include various file indicators 512 that may use assorted names. The names may be determined by the service provider, more specifically, the advertising service provider so that ads may be coordinated to the various files upon selection of the yes key. A file indicator 512 may be provided next to each name 514. If a touch screen is used, selecting the file indicator 512 or the name 514 may open the file to reveal a plurality of advertisements therein. The folders may have names corresponding to the carrier determined identifiers such as restaurants, grocery, clothing, auto service, and spa service. Many different names for categories may be used depending on system design.

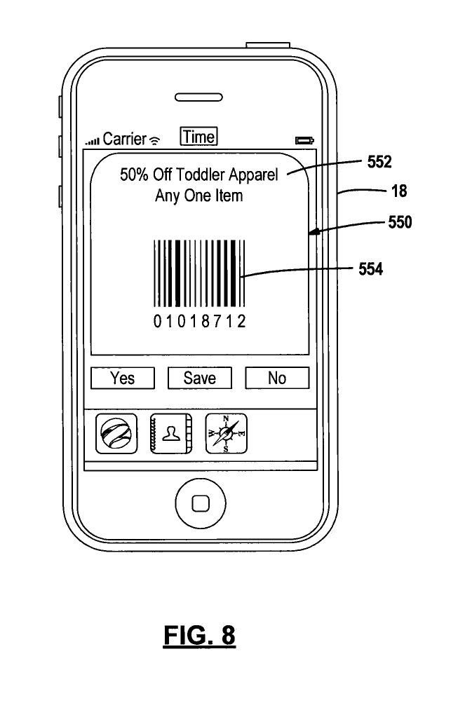

Referring now to FIG. 8, a screen display 550 corresponding to one example of additional information provided to the user device 18 in response to pushing the “yes” key 422 illustrated in FIG. 6. The screen display 550 illustrates a coupon 552 that includes a universal product code 554. The Universal Product Code (UPC) 554 may be scanned at a cash register upon checkout. The coupon 552 may be used just as a paper coupon would be used. The coupon 552 may be provided after selecting the yes button. That is, a coupon signal or additional data signal may be communicated from the carrier 12 to the user device. Alternatively, a link may be provided within the advertisement data so that when the yes key 422 is selected, a link may be followed by the user device to a location for the coupon. In this manner, the advertiser may maintain additional control over the advertisement.

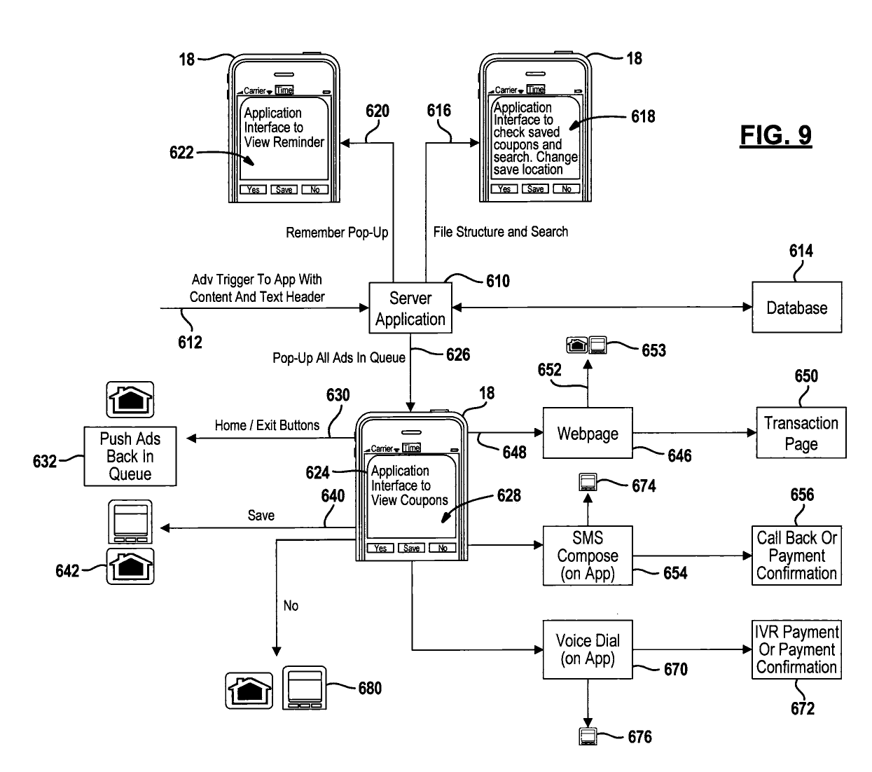

Referring now to FIG. 9, a workflow diagram is illustrated. In the workflow diagram a server application 610 is used for controlling the content pushed or sent to a user device. The server application 610 may be enabled using a trigger signal 612 that triggers the application with content and a text header. The server application 610 may interface with a database 614. The server application 610 may generate user interface screens for performing different functions. For example, the user interface may be used for selecting a file structure search for the file structure illustrated in FIG. 7 above. A file structure and search signal 616 may be used to generate a file structure search screen display 618.

The server application 610 may also generate a reminder pop-up signal 620 that is used to pop up a reminder screen 622 for reminding the user of the user device to check pop-up ads. Either the server or the client application will force advertisements not acted on to show up again in queue. Rules corresponding to terms of service may be provided.

A client application 624 may be used for controlling the user device and pulling content from the server. Pushing and pulling may be controlled by HTTP, SMS or MMS signals. The client application 624 may be stored on the user device 18. It may always be active or placed in a rest or sleep state and awakened every few minutes to receive messages. The application 624 may be initiated manually or by using the server application to enable the application 624.

The server application 610 or client application 624 may also generate a pop-up all ads signal 626 for popping up all ads in a queue. The pop-up all ads signal 626 may provide an application interface screen for interfacing with coupon 628. The application interface 628 may select a home or exit button indicated by signal 630. The home or exit button pushes ads back into the queue in block 632.

A yes or save key may be depressed or selected as indicated by signal 640. The yes or save key 640 may be used to accept further ads or to engage the user. The yes key may perform the actions described above which may obtain further information or save data within the user device as indicated in block 642. Each time a user performs an action on the ad, the server and client application, the “click behavior” is saved into the operational data store or data warehouse used by the server application 610.

After an advertisement is viewed, when available, the user device may perform various functions including obtaining a web page in step 646 by communicating HTML in step 648. A transaction may be performed from the web page by obtaining a transaction page 650. The web page may be cancelled using cancel signal 652 and the user is returned to the application in block 653.

A short messaging service 654 may also be performed. The short messaging service 654 may provide a call-back or payment confirmation 656 for an advertisement that requires a confirmation.

A voice dial application 670 may also be obtained. The voice dial application 670 may allow the user of the user device to interact with an interactive voice recognition system or live person or other type of callback, payment confirmation or other system in step 672.

As described above, an advertisement may solicit various actions in the form of a web page, a short messaging service application, or a voice dial application. Each advertisement may include data for obtaining the desired web page, the content of a text message, or a predetermined phone number for dialing an interactive voice recognition system. At any time, the short-message system may be cancelled in step 674 and the voice dial system may be cancelled in step 676.

If the user selects the YES key, this action may launch a Webpage 648, an SMS 654, or dial a phone number 670. A user may save the advertisement 640 into the file structure of the user device to act upon at a later time. The user may also choose to not view the advertisement by selecting the NO key 680.

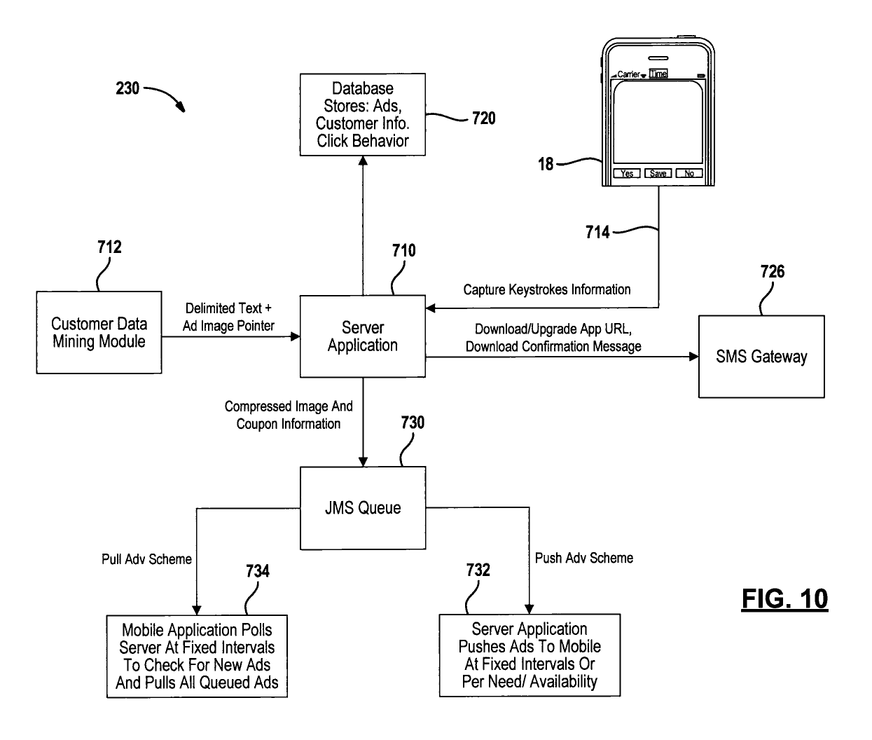

Referring now to FIG. 10, the application server 230 illustrated in FIG. 3 is set forth in further detail. The application server 230 includes a server application 710 that may be implemented in software, hardware, or a combination of both. The application server 710 may receive customer data through a customer data mining module 712. The customer data mining module 712 may provide delimited text and add image pointers to the server application 710. The server application may also capture keystroke information from a user device as indicated by signal 714.

The server application 710 may also interact with database stores 720. The database stores 720 may include ads, customer information, and keystroke or “click behavior.”

The server application 710 may also interface with a short-messaging service (SMS) gateway 726 or SMS Center. The SMS gateway may generate text messages that are communicated to the user devices. The messages may also include MMS messages. The text messages may include various information such as client download instructions or upgrade information, download confirmation messages, and various other messages.

The server application 710 may also generate compressed image information and coupon information. The server application 710 is in communication with a queue 730. The queue may include various advertisements as described above. The advertisements may be queued for each individual user device. The server application 710 may push advertisements from the queue as indicated by box 732. The server application 710 may push ads to the mobile device at fixed intervals or based upon a need or availability.

As indicated by box 734, the client application may poll the server at fixed intervals to check for new ads. Thus, the user device may obtain advertisements by polling the server application or receiving advertisements through a push from the server application. The queue 730 may poll the advertisements based upon the polling.

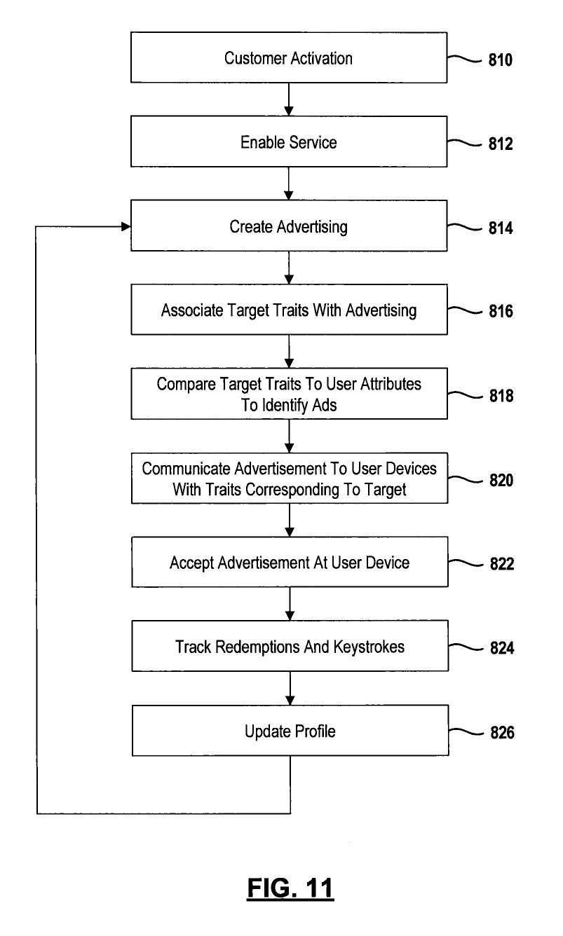

Referring now to FIG. 11, a high-level overview of the process of the present disclosure is set forth. In step 810, a customer is activated into the system. The customer may be activated in several ways, including providing a survey and the like. In step 812, the service is enabled. Service may be enabled by providing an application to the user device. The application may be used to receive the ads and monitor usage. For example, if the application is not enabled, the service may be disabled. Details of steps 810 and 812 will be described below.

In step 814, advertising content is created. Various advertisements may be created by advertisers. In step 816, the target traits are associated with the advertisement. The target traits may coordinate with the various types of demographics and customer information received from a survey. The advertising traits established in step 816 allow the advertisers to specifically target various users.

In step 812, the target traits of the ad are compared with the user attributes to identify ads suitable for communication to a user device. The ads with matching traits may be added to the queue for the user.

In step 820, an advertisement is communicated to a user device and displayed. The advertisements may be pushed or pulled as will be described further below. The ads may be pushed or pulled periodically by the server or pulled by the user device. The advertisement may be communicated to user devices that meet certain characteristics. The display may be a “swing” page that uses midlet technology to overlay a menu page or other running application display with an advertisement. The overlay advertisement generates a visual interrupt on the screen of the user device.

In step 822, the advertisement may be acted upon at the user device. As mentioned above, yes, no or save keys may be selected. In step 824, the redemptions and keystrokes are monitored and communicated back to the carrier 12 or other components of the service provider. In step 826, a user profile may be updated based upon the user redemptions.

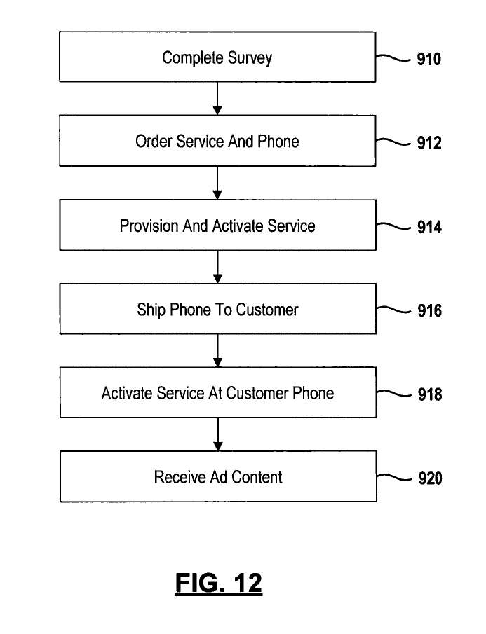

Referring now to FIG. 12, a method for performing customer activation is illustrated in further detail. In step 910, the customer may complete a survey. The survey may include many survey items which were described above. The survey may be completed on-line in an automated fashion or may be manually provided at a customer service center or brick-and-mortar store. Ultimately, the survey responses are compiled for each user device. The survey is used to generate a detailed customer profile that can be matched to advertising traits.

In step 912, the service and phone or other wireless user device is ordered. Various types of phones or personal devices may be used with the present service. The type of service may also be ordered based upon categories of cost. For example, entirely free service may be provided which is subsidized by providing a predetermined number of advertisements. Another type of service may provide a reduced rate plan while reducing the number of advertisements from a completely free plan. Other types of rates may be provided. Free plans may provide a fixed number of minutes and data while the customer may opt for an increased minute plan for additional cost. Another example is the amount of data received. The amount of data received may start at a free base level while increased data plans may require additional costs. The service may be billed on a monthly basis as is traditional in cellular or mobile phones.

In step 914, the service may be provisioned and activated. All the billing information and bookkeeping associated with the account may be performed in this step. In step 916, the customer may be shipped a wireless user device having the application for the service thereon. It should be noted that if the customer enters a brick-and-mortar store, physically handing the handset to a user may be performed in place of this step.

In step 918, activating the service at the customer user device may be provided. Some affirmative action at the user device such as calling a pre-specified number or a customer service center may be required for the activation of the user device. In step 920, ad content may then be received. An initial ad may be provided at this point to confirm the operation of the service.

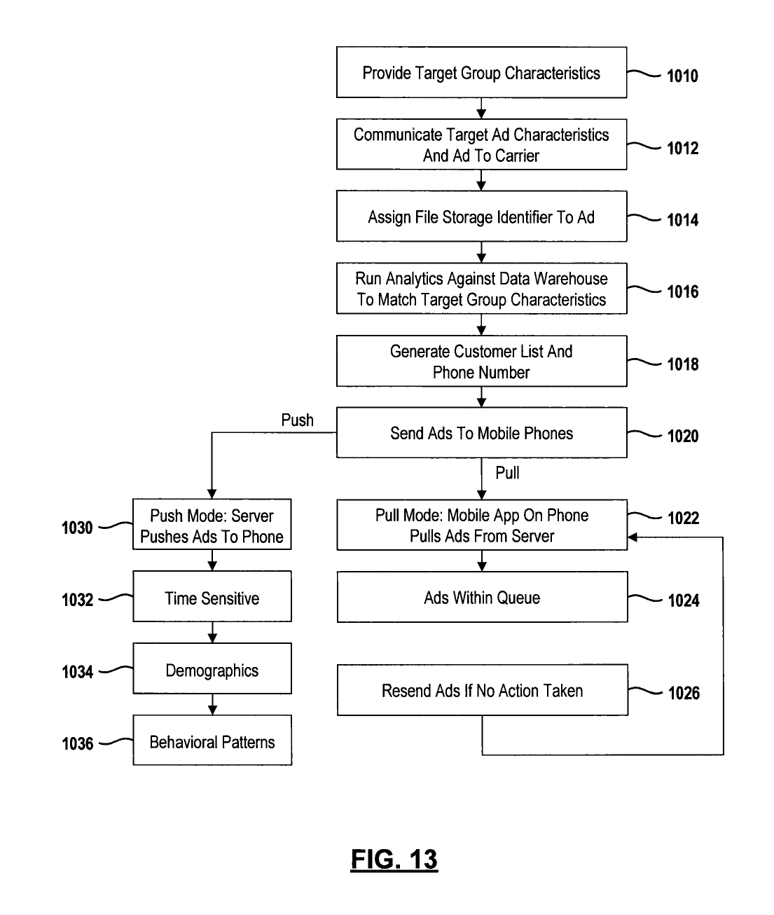

Referring now to FIG. 13, a detailed method for creating and delivering ads is set forth. In step 1010, target group criteria may be provided by the advertisement provider. In step 1012, the target ad characteristics in the ad are provided to the service provider. In step 1014, the ad may be assigned a file storage identifier. The file storage identifier may be associated with the ad by the advertisement provider or by the carrier 12. In step 1016, analytics are run against the data warehouse to match the target group characteristics with user devices and thus the users. In step 1018, a customer list and phone number (or other user device identifier) may be generated by the analytics. The customer list and phone number provide the service provider with the customer list and phone numbers that are best suited for the advertisements.

In step 1020, the advertisements are communicated to the user devices through a network. As mentioned above, there are different ways for communicating with the user device. For example, the ads may be polled by the client application running on the user device in step 1022. The advertisements may be pulled or pushed to the user device by the application server. A polling signal may be provided to poll appropriate advertisements for the user device. In step 1024, the advertisements are stored within a queue within the user device. The ads may be re-sent if no action is taken. That is, the user device may repesent the advertisements if no action is received. Re-sending the advertisements may also be initiated by the carrier or other components of the service provider because no feedback is received. When no keystrokes corresponding to an advertisement are received, the ads may be re-sent or re-queued for the user device so that upon the next poll, the ad may reappear within the user device.

In step 1020, the advertisements may also be pushed to the user devices in step 1030. It should be noted that a combination of push mode and pull mode may be used. Push mode may be provided for time-sensitive advertisements in step 1032, for various demographics in step 1034 and various behavioral patterns in step 1036.

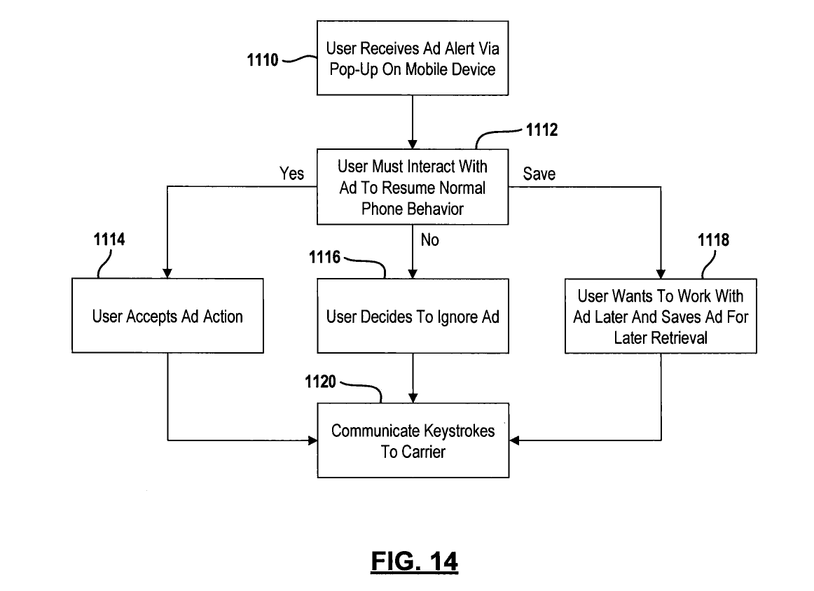

Referring now to FIG. 14, a summary of the customer experience is illustrated. In step 110, the customer receives an advertisement alert via a screen display on the mobile device. The advertising screen display may be displayed from data from the network. In step 1112, the customer must interact with the advertisement to return to the user device's home screen. The user can select a function from the mobile application or hit the home/escape key on their user device to bypass the application. If the advertisement is bypassed, the application will show the same advertisement at a different time interval as defined by the rules of the applications. A lock-out signal may be provided until the normal user device functions are unlocked with the exception of possibly allowing emergency functions. In step 1114, the customer may accept an advertisement action. In step 1114, the customer may accept or obtain further information from the ad action by selecting the yes key on the user device. The customer action may provide further information by way of a link, text message, or further information. If the customer selects the ad, the application may send information from the customer's profile to the advertiser. A consent message may be displayed before this information is sent. After step 1112, by selecting the no key step 1116 may be performed. In step 1116, the advertising may be ignored.

After step 1112, if the save key is selected step 1118 may be performed. In step 1118, the customer may want to save the ad for later retrieval or further work with the ad at a later time period. The client application will categorize the ad and save it to the user device's storage.

After each of the steps 1114, 1116, and 1116, the keystrokes corresponding to an advertisement may be communicated to the carrier. The feedback or keystroke signal from the user device may include an advertisement identifier and keystroke identifier corresponding to the keystrokes performed by the user device.

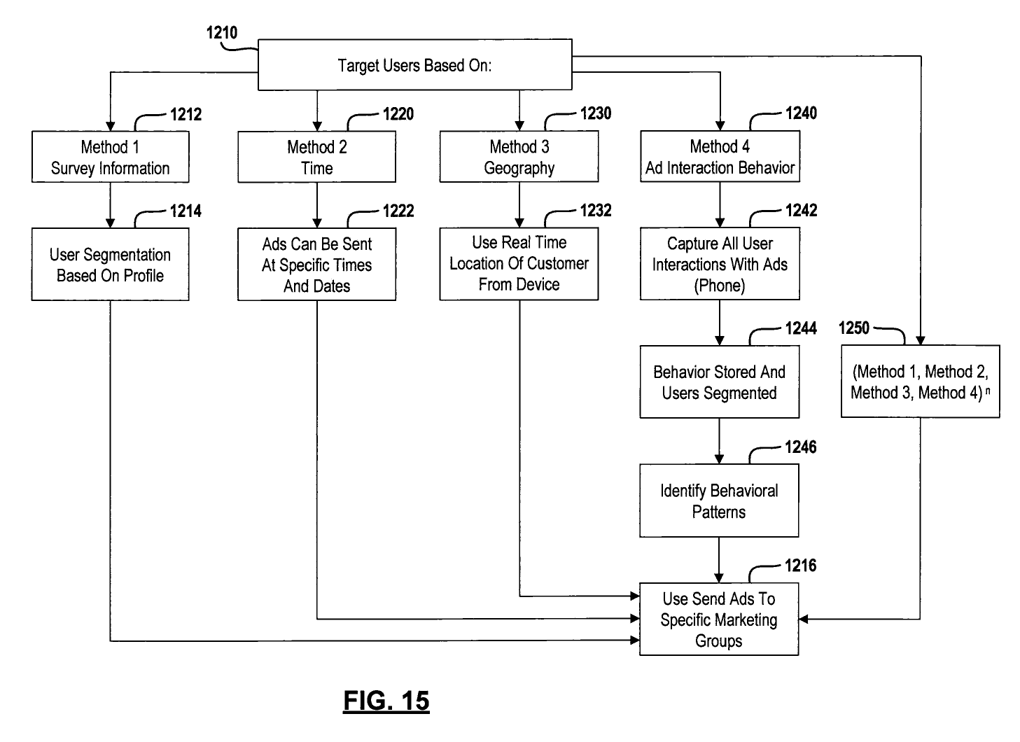

Referring now to FIG. 15, a method of targeting customers is provided. In step 1210, the user devices associated with a user may be targeted in several ways. It should be noted that combinations of the targeting methods may also be provided. Each user has attributes associated therewith. The advertisements have target traits that, when corresponding to a user device or user, may allow an ad to be provided thereto. In step 1210, the user is targeted. In a first method indicated by step 1212, the survey method may be used for targeting. The answers from the survey may be compared based upon the segmentation of the profile in step 1214. Ads are then sent to specific marketing groups having various attributes in step 1216.

In step 1210, if a time method is provided in step 1220, an ad may be sent at specific times and dates in step 1222. For example, some ads may be restricted to different times of the day corresponding to different meals. If a fast-food chain wants to promote a new breakfast item, the ad may be sent between 6:00 a.m. and 10:00 a.m. The ad is then sent according to time and date in step 1216.

In step 1230, a geographical limitation may also be provided for an advertisement in step 1230. In step 1230, the location of a customer based upon feedback from a user device may be obtained in step 1232.

In step 1232, the location or geography of the user device may be provided through the network to the service provider so that appropriate ads based upon location may be provided in step 1216.

Referring back to step 1210, historic ad interaction behavior may also be used to provide ads to customers in step 1240. In step 1242, ad interaction such as keystrokes or click behavior may be obtained from the user device over time. In step 1244, the behavior of the customers interacting with ads and linking to various other information may be captured. In step 1246, the data from steps 1242 and 1244 may be analyzed to determine behavioral patterns. Ads may be sent to the user device in step 1216 based upon behavioral patterns.

Step 1250 symbolizes that the methods of steps 1212, 1220, 1230, and 1240 may be used individually or in various combinations to provide advertisements to the user devices. Some ads, for example, may have geographical limitations and not time limitations. Some ads may merely use survey information. Ad interaction behavior may also be used together or alone with other ad criteria. For example, if a certain type of store or product is continually selected by the customer, ads directed to that customer for further products may be targeted to the user device associated with the user.

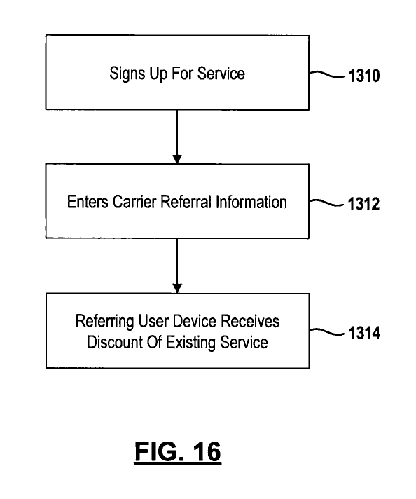

Referring now to FIG. 16, a method for providing a referral to another user is set forth. In step 1310, a user may obtain a reduced rate or further reduced rate when referring another customer into this service provider system. In step 1310, a referral recipient may sign up for services at the service provider. In step 1312, the service provider may enter the referral information that corresponds to the referring user device.

In step 1314, the referring service device may receive a discount of existing services. For example, when the referring user device has a first rate plan that requires a monthly fee, a reduced monthly fee at a second rate may be provided based upon a referral. This may be performed in several ways with respect to the monthly fees. The monthly fees may be reduced a fixed increment per user device signed up until the service is free. Another way in which the rate plans may be implemented is providing a reduced rate so long as the referred user device continues with the service. If free service is provided to the referring user device, every referral may result in a credit or check being provided to the user of the referring user device.

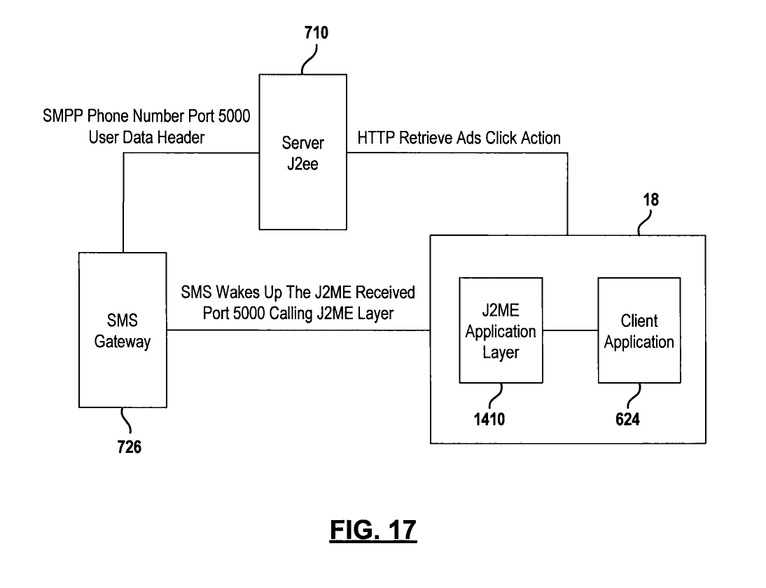

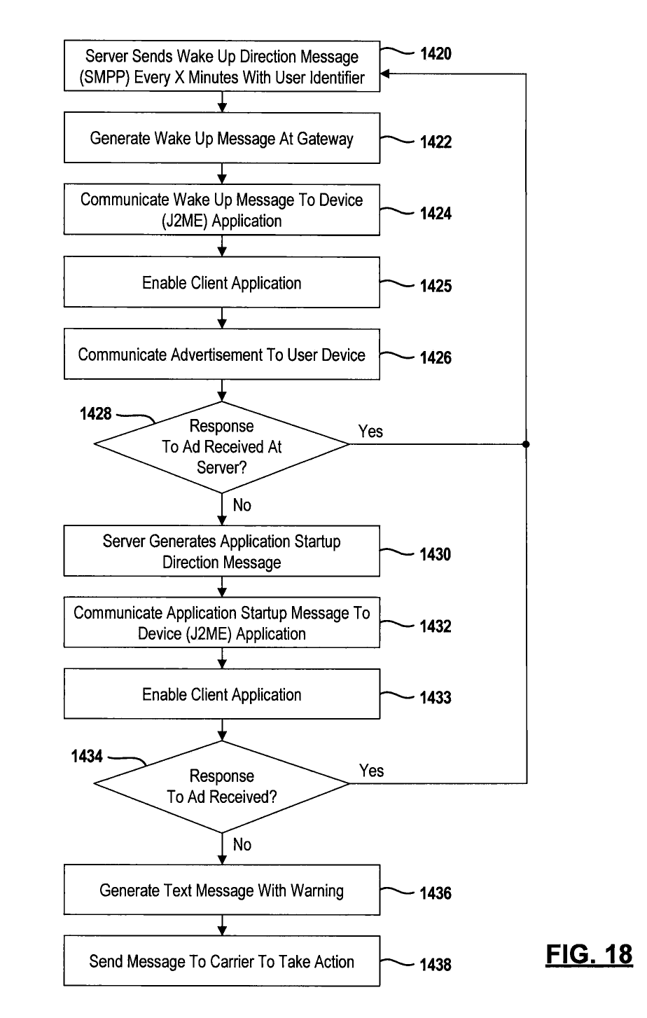

Referring now to FIG. 17, a system for waking up and initiating an application is set forth. When delivering advertisements to a device the application for receiving and displaying ads on the user device may not continually operate so that battery life of the user device is extended. Further, it may be possible for the application to be disabled intentionally or unintentionally. FIGS. 17 and 18 are directed to enabling the user device application to receive advertisements.

The application server 710 may be a J2EE server. The J2EE server 710 is in communication with the SMS Gateway 726. The SMS Gateway 726 is in communication with the user device 18 and in particular the J2ME application layer 1410 of the user device 18 which is in communication with the client application 624. The client application 624 may wake up or become active every predetermined number of minutes. Timed wake up is used for periodic wake up so that new ads may be received. The client application 624 may also be awakened on demand. On demand awakening is useful when an advertisement has a predetermined time for deployment such that immediate receiving and displaying by the phone is desirable.

Referring now to FIGS. 17 and 18, to wake up the application at a predetermined time the server 710 communicates a wake up direction message to the SMS Gateway 726. The direction messages described herein provide a request with directions and data for initiating a type of message. The wake up direction message may be in the form of a short message peer-to-peer protocol (SMPP) that may include various identifying data such as the phone number of the user device, a port number such as port 5000 and a user data header. Step 1420 of FIG. 18 sends the wake up direction message in response to the wake up direction message. In step 1422 the gateway generates a wake up message. The gateway 726 may generate an SMS signal that communicates with the J2ME application layer. In step 1424 the gateway communicates the SMS message to the J2ME port 5000 of the client application layer 1410 which is in communication with the client application 624. The client application is enabled to receive messages in response to the wake up message in step 1425. In step 1428 an advertisement may be communicated to the user device from the server 710. Steps 1420 through 1426 may act alone or may also be used with the following steps.

In step 1428, the server determines whether a response to an advertisement was received. Various key stroke actions may be recorded by the server to determine whether the advertisement has been interacted with. In step 1430 if no response has been received at a server or server application for a predetermined period of time this may indicate that the user device has been disabled or the client application has been disabled. In step 1430 the server generates an application start up direction message which is communicated to the gateway. In step 1432 the gateway initiates the start up of the client application by communicating a start up message to the J2ME application layer 1410 of the user device 18. The client application is enabled to start up in step 1433. In step 1434 if a response to the ad has been received within a predetermined amount of time the system returns to step 1420 or ends operation.

In step 1434 if a response to the ad has not been received step 1436 generates a text message with a warning. This is an optional step that may be implemented to warn the user of the user device that service may be terminated in violation of the original start up agreement. The text message may provide a warning that responses to ads must be received within a predetermined amount of time such as eight hours or the service will be suspended. In step 1438, the carrier may be sent a message to take further action. The carrier may then take further action such as suspending service or disabling at least a portion of the user device for not complying with the warning text message. Both of steps 1436 and 1438 may be used together, alone, or not at all.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. A method comprising:
communicating an advertisement to a user device;
generating a first screen display at the user device comprising the advertisement;
prior to accessing user device functions, interacting with the advertisement on the first screen display; and
in response to interacting with the advertisement, accessing a user device function.

2. A method as recited in claim 1 further comprising providing a wireless service plan from a service provider based upon communicating the advertisement and interacting with the advertisement.

3. A method as recited in claim 1 further comprising:
associating attributes with the user device;
associating advertising traits to an advertisement; and
comparing attributes with the advertisement.

4. A method as recited in claim 3 wherein associating attributes with a user device comprises providing a survey to a user and determining attributes in response to the survey.

5. A method as recited in claim 4 wherein determining attributes comprises determining at least one of user gender, user age, home address, income, marital status, spouse's age, children's ages, children's gender, education level and recreational interests.

6. A method as recited in claim 4 wherein providing a survey comprises providing the survey from a point of contact.

7. A method as recited in claim 1 wherein generating a first screen display at the user device comprises displaying the advertisement having interaction buttons.

8. A method as recited in claim 7 wherein displaying the advertisement comprises displaying at least two interaction keys.

9. A method as recited in claim 8 wherein displaying the advertisement comprises displaying at least three interaction keys.

10. A method as recited in claim 7 wherein displaying the advertisement comprises displaying a yes key, a save key, and a no key.

11. A method as recited in claim 10 wherein interacting comprises interacting with the yes key, the save key, or the no key.

12. A method as recited in claim 11 wherein interacting comprises interacting with the yes key, the save key, or the no key comprises generating keystroke signals, and further comprising communicating the keystroke signals to the service provider, and updating attributes associated with a user device.

13. A method as recited in claim 11 wherein interacting with the yes key comprises generating a second screen display comprising an information screen associated with the advertising.

14. A method as recited in claim 11 wherein interacting with the yes key comprises communicating a yes signal to the service provider and communicating a data signal for a second screen display to the user device corresponding to an information screen corresponding to the advertisement.

15. A method as recited in claim 11 wherein interacting with the yes key comprises communicating a yes signal to the service provider and communicating a link signal for a second screen display, wherein said user device receives the second screen display using the link.

16. A method as recited in claim 1 further comprising generating keystroke signals in response to interacting and further communicating key stroke signals and an ad identifier to the service provider.

17. A method as recited in claim 16 further comprising storing the keystroke signals and the ad identifier at the service provider.

18. A method as recited in claim 17 further comprising communicating a billing signal to the advertiser in response to the key stroke signal.

19. A method as recited in claim 1 further comprising referring a second user to the service provider by a user associated with a first user device, lowering a rate plan to a first reduced rate for the first user device in response to referring.

20. A method as recited in claim 1 further comprising forming a user device queue having a plurality of advertisements therein at the service provider prior to communicating the advertisement.

21. A method as recited in claim 1 further comprising determining a user device geographic location, communicating a location signal corresponding to the geographic location to the service provider, and wherein communicating the advertisement comprises communicating the advertisement from the service provider to a user device based on the location signal.

22. A method as recited in claim 1 further comprising determining a time and wherein communicating the advertisement comprises communicating the advertisement based on the time.

23. A method as recited in claim 1 further generating an ad interaction signal and wherein communicating the advertisement comprises communicating the advertisement based on the ad interaction signal.

24. A method as recited in claim 1 wherein accessing a user device function comprises accessing a voice system.

25. A method as recited in claim 1 wherein accessing a user device function comprises accessing a data system.

26. A method as recited in claim 1 wherein prior to communicating an advertisement, enabling a client application to receive the advertisement from a server.

27. A method as recited in claim 1 further comprising when a response has not been received at a server, generating a startup message and communicating the startup message to the user device to initiate the client application for receiving the advertisement.

28. A method as recited in claim 27 further comprising generating a direction message to a message gateway to initiate the startup message.

29. A method as recited in claim 27 further comprising when a response has not been received after communicating the startup message, disabling at least a portion of the user device.
